(19) United States
(12) Patent Application Publication
(10) Pub. No.: US 2006/0051665 A1
(43) Pub. Date: Mar. 9, 2006

(54) Electrochemical cell presenting two current output terminals on a wall of its container

(75) Inventors: Gerard Rigobert, Fargues St Hilaire (FR); Claude Gilabert, Le Pian Medoc (FR); Philippe Jonac, Gradignan (FR); Dominique Ligeois, Mignaloux Beauvoir (FR)

Correspondence Address: SUGHRUE MION, PLLC, 2100 PENNSYLVANIA AVENUE, N.W., SUITE 800, WASHINGTON, DC, 20037, US

(73) Assignee: SAFT

(21) Appl. No.: 11/036,373

(22) Filed: Jan. 18, 2005

(30) Foreign Application Priority Data
Sep. 7, 2004 (FR) 0409451

(51) Int. Cl. H01M 2/06; H01M 2/08; H01M 10/04

(52) U.S. Cl. 429/179; 429/184; 29/623.2; 29/623.4

(57) ABSTRACT

A cell comprises a container and two current output terminals made of copper situated on a single wall of the container. Each of the current output terminals presents a shoulder. A first terminal is secured to the wall by laser welding, and a second terminal is secured through the wall by crimping with axial displacement of material. The invention facilitates operations of installing and maintaining cells connected together within a module by copper bars. It avoids damaging connections by repeated screwing and unscrewing of nuts screwed onto the terminals when using a screw-and-nut connection system for connecting to the bars.

The present invention relates to an electrochemical cell presenting two current output terminals on an end wall of its container. It also relates to a method of manufacturing such a cell.

### BACKGROUND OF THE INVENTION

An electrochemical cell (or “battery”) is a device for producing electricity in which chemical energy is converted into electrical energy. The chemical energy is constituted by electrochemically active compounds deposited on at least one face of electrodes disposed in the cell. The electrical energy is produced by electrochemical reactions while the cell is discharging. The electrodes, which are placed in a container, are electrically connected to current output terminals which provide electrical continuity between the electrodes and a consumer of electricity or “load” with which the cell is associated. The positive and negative current output terminals may be secured either to the walls of opposite faces of the cell container, or to the wall of a single face of the container.

A plurality of cells can be connected together in series or in parallel or in a series/parallel configuration as a function of the nominal operating voltage of the load and of the quantity of energy (in ampere hours) which is to be supplied to the load. The cells are then placed in a common case and the assembly comprising the case with a plurality of cells contained therein generally being referred to as a module or a monoblock. The cells in a module are interconnected by metal bars, e.g. made of copper.

In the special case of lithium ion type cylindrical cells, the electrodes are assembled as a spiral winding to form an electrochemical stack, and they are inserted in a metal container of cylindrical shape. The current output terminals are often situated on opposite end faces of the container. That disposition does not facilitate assembling cells as a module since the terminals situated on the rear faces of the cell are then difficult to access, and that disposition requires the terminals of the cells to be wired in a manner that is more complex than when the current output terminals are both situated on a wall at a single end.

Placing the terminals on the same wall at one end of the container of a cylindrical lithium ion cell makes it easier to mount and remove cells. The current output terminals are generally situated on the cover of the cell, and they are made of materials of different kinds, usually copper for the negative terminal and aluminum for the positive terminal (for lithium ion cell technology). The connection between a terminal and a bar is made either by welding or by screw-fastening. The connection between a copper terminal and a copper bar by screw-fastening or by welding is achieved in either case in satisfactory manner since copper possesses sufficient mechanical strength to provide a good contact surface between the terminal and the bar, and welding copper to copper presents no particular problem.

However, connecting an aluminum terminal to a copper bar by screw-fastening or by welding does not give satisfactory results. The positive terminal made of aluminum does not possess sufficient mechanical strength to guarantee a good contact surface with the copper bar; the thread on the aluminum terminal can also be damaged if the tightening torque applied to the nut screwed onto the terminal is too great. Furthermore, welding aluminum and copper together is difficult because of the natures of the metallic structures of those two materials, and also because of their different melting temperatures.

### OBJECTS AND SUMMARY OF THE INVENTION

There therefore exists a need for a cell presenting two current output terminals made of copper that are situated on a single wall of the cell container.

To this end, the invention provides an electrochemical cell comprising a container and two current output terminals made of copper situated on a single wall of the container, each of the current output terminals presenting a shoulder.

In various embodiments, the cell presents one or more of the following characteristics:
a first terminal is secured to the wall by laser welding;
a second terminal is secured through the wall by crimping;
the crimped terminal presents axial displacement of material;
the crimped terminal presents at least one gasket of polyetherimide; and
the first terminal is the positive terminal and the second terminal is the negative terminal.

Depending on the application, the cell container is cylindrical or prismatic in shape; the cell may be of the lithium ion, nickel cadmium, or nickel metal hydride type. Cells of these types are rechargeable, they are also known as “secondary cells”, or as “accumulators”.

The invention also provides a method of manufacturing a cell comprising a container and two current output terminals made of copper situated on a single wall of the container, each of the current output terminals presenting a respective shoulder, and in which one of the terminals is secured by laser welding comprising the steps consisting in:
placing the shoulder of the terminal on the wall;
covering the shoulder in a washer suitable for transmitting laser energy; and
laser welding the shoulder to the wall.

According to a characteristic, the washer is made of nickel.

According to a characteristic, the laser beam is directed perpendicularly to the surface of the washer.

Depending on the application, the terminal secured by laser welding is the positive terminal; the cell is cylindrical and of the lithium ion type.

The invention also provides a method of manufacturing a cell comprising a container and two current output terminals made of copper and situated on a single wall of the container, each of the current output terminals presenting a shoulder, and in which one of the terminals is secured by crimping comprising the steps consisting in:
forming an opening through the wall;
placing at least one gasket around the opening in the wall;
placing a bearing washer on the gasket;
inserting the terminal through the washer and the at least one gasket; and
securing the terminal by crimping with axial displacement of material.

According to a characteristic, a portion of the surface of the gasket adjacent to the wall presents a rib suitable for engaging in the wall during crimping.

Depending on the application, the terminal secured by crimping is the negative terminal; the gasket is made of polyetherimide; the cell is cylindrical and of the lithium ion type.

### BRIEF DESCRIPTION OF THE DRAWINGS

Other characteristics and advantages of the invention appear on reading the following description given by way of example and with reference to the figures which show:

FIG. 1 is a longitudinal section view of a sealed lithium ion cylindrical cell provided with two copper terminals in accordance with the invention;

FIG. 2 is a longitudinal section of a current output terminal fastened to the cover by welding;

FIG. 3A is a longitudinal section view of a current output terminal fastened to the cover by crimping, using a prior art technique;

FIG. 3B is a longitudinal section view of a current output terminal secured to the cover by crimping in accordance with the invention, dashed lines represent the outline of the deformed portion of the terminal after crimping; and

FIG. 3C is a longitudinal section view of a current output terminal secured to the cover by crimping in a variant implementation of the invention.

### MORE DETAILED DESCRIPTION

The invention relates to a cell comprising a container and two current output terminals made of copper situated on a single wall of the container, each of the current output terminals possessing a shoulder. A first terminal may be fastened to the wall by laser welding. A second terminal may be fastened through the wall by crimping with axial displacement of the material.

The invention facilitates operations of maintaining cells connected together within a module. It avoids the connections suffering damage due to repeated screwing and unscrewing of nuts screwed onto the terminal as occurs in a bar type connection system using screws and nuts.

The invention is described in a preferred embodiment given by way of example with reference to a cylindrical lithium ion cell, even though the invention can be applied to other cell technology.

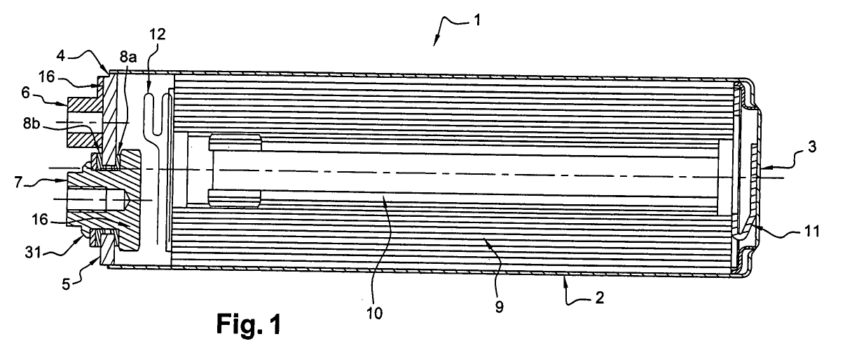

FIG. 1 is a longitudinal section of a sealed cylindrical lithium ion cell of the invention.

The cell 1 comprises an aluminum container presenting a cylindrical wall 2 closed by a bottom 3 at one end and open at the other end 4. An aluminum cover 5 is placed on the open end. It supports the current output terminals 6 and 7.

The current output terminals are made of copper, and they are preferably tinned when the connection to a metal bar is made by welding. They are made of copper and preferably tinned or covered in silver when the connection to a metal bar is made by screw-fastening. The copper could also be covered in nickel to avoid oxidation.

A first current output terminal, in this example the positive terminal 6, is welded to the cover by laser. A second current output terminal in this example the negative terminal 7, passes through the cover. It is fastened thereto by crimping with axial displacement of the material 31 constituting the terminal. Two gaskets 8a and 8b insulate the negative current output terminal 7 electrically from the cover. The electrochemical stack 9 constituted by a winding of positive and negative electrodes and separators is placed around a hollow shaft 10 which serves as a chimney for gas. A connection strip 11 connects the positive electrode of the stack to the bottom wall of the container, the walls of the container being electrically conductive and in connection with the cover. A connection strip 12 connects the negative electrode of the stack to the negative current output terminal.

In an embodiment, the wall of one of the ends of the cylindrical container, preferably the cover, is used as a support to which both current output terminals are secured, and the bottom of the cylindrical container is used as a location for a safety device suitable, for example, for releasing venting excess pressure from inside the container and/or suitable for interrupting the flow of electrical current in the circuit.

The invention is thus suitable for all known lithium ion cell technologies (e.g. having a cathode based on lithium-containing oxides of transition metals Ni, Co, or Mn, and anodes based on carbon or on Li₄Ti₅O₁₂), for which it is desired to find techniques that improve user safety when the cell is caused accidentally to operate outside its nominal conditions.

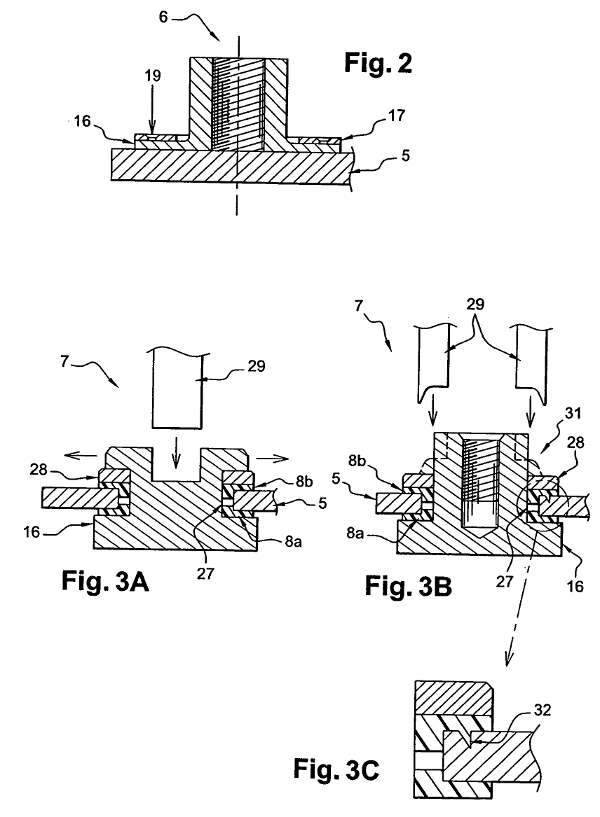

The technique whereby the positive current terminal is fastened to the surface of the cover wall by welding is described below with reference to FIG. 2.

The terminal 6 forms a peg of round section which can be provided with a thread on its surface. At its base, the peg presents a sudden change in section, referred to below as a “shoulder” 16 which is used as a bearing surface for bearing against the wall of the cover 5.

The welding operation is performed by emitting a continuous laser beam at a power of 2 kilowatts (kW) for a length of time that is sufficient to allow welding to take place. In a preferred implementation, the laser beam is directed perpendicularly to the bearing surface of the terminal in the direction represented by arrow 19. However, an angle of impact for the laser beam relative to the wall other than 90° could also be envisaged.

A nickel washer 17 is placed on the shoulder. Welding the terminal to the cover by means of a laser with direct impact of the laser beam on the shoulder is not very effective. The copper surface of the shoulder reflects the laser beam and the heat energy supplied by the laser beam is not transmitted to the bearing surface of the terminal against the wall of the cover. The function of the washer is to transmit the heat energy of the laser beam to the bearing surface of the terminal bearing against the wall of the cover.

The thickness of the shoulder 16 of the terminal 6 is about 0.8 millimeters (mm). The thickness of the nickel washer 17 is about 0.5 mm.

The terminal could be secured under the wall of the cover so that the shoulder bears against the inside face of the wall of the cover and the terminal passes through the wall of the cover via an opening made in the wall of the cover. Such an embodiment would not go beyond the ambit of the invention.

The method of securing the negative current terminal through the wall by crimping is described below with reference to FIGS. 3B and 3C. FIG. 3A does not show the invention but shows a prior art method of crimping. Crimping consists in applying pressure to a part so as to deform it against another part for the purposes of establishing a mechanical connection between the two parts. Crimping enables two parts to be held together without welding. This method applies to securing a current terminal to the wall of the lid of a cell guarantees firstly that the terminal is held axially in place, i.e. prevented from moving along its own longitudinal axis, and secondly that it is held radially in place, i.e. perpendicularly to its longitudinal axis, where the longitudinal axis of the terminal is defined as being the axis along its greatest length.

The negative current output terminal is assembled through the cover as follows.

A circular opening is made through the wall of the cover 5. An inside gasket 8a is mounted around said opening in contact with the inside face of the wall of the cover. An outside gasket 8b is placed around the opening being mounted in contact with the outside face of the wall of the cover. In this example, the two gaskets are identical. The gaskets are selected to be made of a material that is elastic, electrically insulating, and of hardness that is preferably slightly greater than the hardness of the material from which the cover is made. It is preferred to use polyetherimide (PEI). The thickness of the gaskets is determined so that once they have been put into place and crimping has been performed, assembly clearance 27 remains present between the gaskets. The presence of this clearance serves to absorb variations in the dimensions of these gaskets or of the terminal that can occur during operation of the cell under the effect of temperature. This clearance also serves to absorb a small increase in the compression force used for crimping purposes. Without this clearance, any increase in the crimping pressure would run the risk of damaging the gasket.

A bearing washer 28 having the same inside and outside diameters as the outside gasket 8a is placed thereon. During crimping, its function is to serve as an abutment against displacement of the material constituting the terminal and to transmit the pressure force to the outside gasket 8a. Any other bearing plate could also be envisaged. The washer may be made of steel.

The terminal, which is in the form of a peg of round section and presents a shoulder 16 at its base of diameter not less than the outside diameter of the gaskets 8a and 8b, is inserted through the inside diameters of the gaskets and the washer 28. The shoulder constitutes a bearing surface enabling the peg to bear against the inside surface of the inside gasket 8b, i.e. the surface of the gasket that is exposed to the inside of the cell container.

Crimping is performed by using a tool 29 to flatten a portion of the end of the peg situated remote from the shoulder against the surface of the metal washer. The flattened portion is in the form of a ring 31. Crimping imparts axial displacement of the material towards the washer. The material moved by crimping comes into abutment against the washer, thereby preventing the peg from sliding in the axial direction.

The peg is also prevented from moving in the radial direction, since under the effect of the compression in the axial direction, the gaskets deform in the radial direction, thereby absorbing any clearance between the diameter of the peg and the inside diameter of the gaskets.

The method of crimping by causing material to be displaced in the axial direction is thus well adapted to compensating for the clearances that result from assembling parts having tolerances that might have fluctuated during machining.

In a preferred embodiment of the invention, the surface of the outside gasket that comes into contact with the wall of the cover is provided with a circular rib 32 as shown in FIG. 3C. Under the effect of the pressure, the circular rib is suitable for penetrating into the wall of the cover since the gasket is made of material that is harder than the aluminum of the cover. Sealing between the gasket and the wall of the cover is thus improved. It is advantageous to use polyetherimide in this embodiment since it presents hardness that is close to or slightly greater than the hardness of aluminum over a wide range of temperatures.

The circular rib could be situated on the face of the inside gasket without such an embodiment departing from the ambit of the invention.

Compared with crimping with radial displacement of material (FIG. 3A), the method of crimping with axial displacement presents the advantage of not deforming the central portion of the terminal. A thread can thus be formed on the central portion of the terminal for the purpose of enabling a bar to be secured thereto by a screw-and-nut system.

Securing a terminal by crimping presents the following advantages compared with securing it by screw-fastening.

Firstly, from the industrial point of view, assembling a terminal by crimping is faster than assembling it by a screw-fastener system, which requires an electrically insulating material to be inserted initially in the opening of the cover followed by making a thread on said material in order to screw the terminal thereto.

In addition, securing by means of crimping provides a better contact surface between the terminal and the wall of the cover than does securing by screw-fastening. Consequently, sealing against the gases generated inside the cell is improved.

In addition, crimping presents better temperature performance. The sealing of the cell is degraded to a small extent by temperature variations or by prolonged operation at high temperature.

The present embodiment and the figures should be considered as being presented in non-restrictive and illustrative manner, and the invention is not limited to the details provided herein, but can be modified while remaining within the ambit and the scope of the accompanying claims. In particular, the current output terminal that is welded to the wall of the cover could be the negative terminal and the current output terminal secured by crimping through the cover could be the positive terminal. The invention also applies to cells of prismatic shape and to cells implementing other technologies (Ni—Cd, Ni—MH, etc.).

What is claimed is:

1. An electrochemical cell comprising a container and two current output terminals made of copper situated on a single wall of the container, each of the current output terminals presenting a shoulder.

2. A cell according to claim 1, in which a first terminal is secured to the wall by laser welding.

3. A cell according to claim 1, in which a second terminal is secured through the wall by crimping.

4. A cell according to claim 3, in which the crimped terminal presents axial displacement of material.

5. A cell according to claim 3, in which the crimped terminal presents at least one gasket of polyetherimide.

6. A cell according to claim 1, in which the first terminal is the positive terminal.

7. A cell according to claim 1, in which the second terminal is the negative terminal.

8. A cell according to claim 1, wherein the shape of its container is cylindrical.

9. A cell according to claim 1, wherein the shape of its container is prismatic.

10. A cell according to claim 1, the cell being of the lithium ion type.

11. A cell according to claim 1, the cell being of the nickel cadmium type.

12. A cell according to claim 1, the cell being of the nickel metal hydride type.

13. A method of manufacturing a cell comprising a container and two current output terminals made of copper situated on a single wall of the container, each of the current output terminals presenting a respective shoulder, and in which one of the terminals is secured by laser welding comprising the steps consisting in:
placing the shoulder of the terminal on the wall;
covering the shoulder in a washer suitable for transmitting laser energy; and
laser welding the shoulder to the wall.

14. A method of manufacturing a cell according to claim 13, in which the washer is made of nickel.

15. A method of manufacturing a cell according to claim 13, in which the laser beam is directed perpendicularly to the surface of the washer.

16. A method of manufacturing a cell according to claim 13, in which the terminal secured by laser welding is the positive terminal.

17. A method of manufacturing a cell according to claim 13, in which the cell is cylindrical and of the lithium ion type.

18. A method of manufacturing a cell comprising a container and two current output terminals made of copper and situated on a single wall of the container, each of the current output terminals presenting a shoulder, and in which one of the terminals is secured by crimping comprising the steps consisting in:
forming an opening through the wall;
placing at least one gasket around the opening in the wall;
placing a bearing washer on the gasket;
inserting the terminal through the washer and the at least one gasket; and
securing the terminal by crimping with axial displacement of material.

19. A method of manufacturing a cell according to claim 18, in which a portion of the surface of the gasket adjacent to the wall presents a rib suitable for engaging in the wall during crimping.

20. A method of manufacturing a cell according to claim 18, in which the terminal secured by crimping is the negative terminal.

21. A method of manufacturing a cell according to claim 18, in which the gasket is made of polyetherimide.

22. A method of manufacturing a cell according to claim 18, in which the cell is cylindrical and of the lithium ion type.
